(19) United States
(12) Patent Application Publication
(10) Pub. No.: US 2013/0228402 A1
(43) Pub. Date: Sep. 5, 2013

(54) PARKING BRAKE IN A VEHICLE

(71) Applicants: Oliver LEIBFRIED, Siegelsbach (DE); Alexander PAESSLER, Tamm (DE)

(72) Inventors: Oliver LEIBFRIED, Siegelsbach (DE); Alexander PAESSLER, Tamm (DE)

(73) Assignee: Robert Bosch GmbH, Stuttgart (DE)

(21) Appl. No.: 13/782,597

(22) Filed: Mar. 1, 2013

(30) Foreign Application Priority Data
Mar. 2, 2012 (DE) 10 2012 203 335.1

(51) Int. Cl. B60T 13/74; B60T 1/06

(52) U.S. Cl. CPC B60T 13/74; B60T 1/065
USPC 188/72.1

(57) ABSTRACT

A parking brake in a vehicle has one wheel-brake unit on each of two vehicle wheels, each having one DC brake motor for generating a clamping force which holds the vehicle at a standstill. The electric brake motors are controllable via a control unit, each brake motor being assigned one H-bridge and the H-bridges being interconnected in such a way that one shared half-bridge branch having switches for controlling both brake motors is formed.

### BACKGROUND OF THE INVENTION

1. Field of the Invention

The present invention relates to a parking brake in a vehicle.

2. Description of the Related Art

Electromechanical parking brakes are known for generating a clamping force which holds the vehicle at a standstill with the aid of an electric brake motor. When the brake motor is activated, a brake piston, which is the carrier of a brake lining, presses against a brake disk. Such a parking brake is known from German patent document DE 103 61 042 B3, for example.

The parking brake usually acts upon the wheel brake units of both wheels of the rear axle, each wheel brake unit being assigned an electric brake motor for generating the desirable clamping force. During the engagement process for building up the clamping force, the electric brake motors are controlled via an assigned control electronics in one direction, and for releasing the clamping force, the brake motors are controlled in the opposite direction. The control unit typically includes one H-bridge circuit and one associated driver unit per brake motor for controlling the electromechanical relays or transistors in the H-bridges.

### BRIEF SUMMARY OF THE INVENTION

An object of the present invention is to control, using simple measures, a parking brake in a vehicle which has wheel brake units, each having one brake motor on two vehicle wheels, in a simple and space-saving manner.

The parking brake according to the present invention may be used in vehicles to generate a clamping force which holds the vehicle at a standstill. The parking brake has an electromechanical braking device which includes an electric DC brake motor. The parking brake is assigned two wheel brake units, each having one electric brake motor. The wheel brake units having the electric brake motor are preferably located on the opposite wheels of a common axle, in particular of the rear axle of the vehicle.

During a rotational movement of the electric brake motor, a final control element executes an actuating motion via which a brake piston, which is the carrier of a brake lining, is pressed axially against a brake disk of the wheel brake unit for generating the desirable clamping force. This engagement process is carried out until the desirable setpoint clamping force is reached. To disengage the parking brake, the brake motor is activated in the opposite direction so that the brake piston and the brake lining are removed from the brake disk.

If necessary, the hydraulic pressure of the regular vehicle brake may act upon the brake piston to decelerate the vehicle while driving. Basically, the hydraulic pressure of the vehicle brake may also be active when the vehicle is at a standstill and may result in an additional clamping force which adds to the electromechanically generated clamping force of the brake motor.

The engagement and the disengagement processes of the two electric brake motors take place simultaneously at the different wheels. The control is carried out with the aid of a control electronics which is designed as an H-bridge in the embodiment of the parking brake according to the present invention. Each brake motor is assigned one H-bridge, the H-bridges being interconnected in such a way that the two H-bridges have a shared half-bridge branch having two switches, in particular transistors, and the shared half-bridge branch is used to control both brake motors. Thus, there is a shared control electronics for both brake motors, the design including the double H-bridge having one shared half-bridge branch allowing for an independent switching of the two brake motors, while the motors, however, rotate in the same direction of rotation during the engagement and the disengagement processes.

This design has the advantage that one half-bridge branch having two switches may be omitted compared to a design having two separate H-bridges. In the embodiment according to the present invention, the control electronics comprises a total of three half-bridge branches, the middle half-bridge branch being assigned to both DC brake motors. By omitting one half-bridge branch having two switches or transistors, it is also possible to save printed-board space so that the control unit may have a smaller design.

Advantageously, fully electronic H-bridges having transistors as switches, e.g., MOSFETs, are used. Basically, other H-bridges having electromechanical relays are, however, also possible.

According to one advantageous embodiment, the control unit has one shared driver unit for controlling the switches in the H-bridges. All six switches in the three individual half-bridge branches may be controlled via the shared driver unit for the H-bridges of the two brake motors in such a way that the current flows in the one or the other direction through the two electric motors in order to carry out the engagement and the disengagement processes. The driver unit may be a so-called B6 or three-phase bridge circuit, for example, which is available as a standard circuit and is usually used for three-phase motors. When used in the parking brake according to the present invention which has two DC brake motors, the six switches of the H-bridges may be controlled and switched via the B6 bridge circuit.

According to another advantageous embodiment, measuring devices are provided for measuring the motor currents through the two brake motors. The instantaneous clamping force may be inferred from the motor current so that during the engagement process, the electric brake motors are activated until the desirable setpoint clamping force is reached.

In particular, when using a B6 bridge circuit as the driver unit, it may have a total of three measuring devices, of which two measuring devices are used to measure the current of the brake motors and the third measuring device may be used to redundantly measure the current, in particular to check the current measurements of the two brake motors for plausibility.

The brake motors are advantageously designed as DC motors. According to one advantageous embodiment, the control of the brake motors may take place without pulse width modulation (PWM), in that the current flow is maintained until the desirable setpoint clamping force is reached. However, a control and regulation via a PWM is basically also possible.

To prevent a false polarity, a polarity reversal protection is advantageously integrated into the voltage supply line of the electric brake motors.

### BRIEF DESCRIPTION OF THE DRAWINGS

FIG. 1 shows a section through an electromechanical parking brake for a vehicle having an electric brake motor for generating a clamping force which holds the vehicle.

FIG. 2 shows a wiring diagram for controlling electric brake motors in a vehicle.

FIG. 3 shows another wiring diagram for controlling electric brake motors having measuring devices for measuring the current.

### DETAILED DESCRIPTION OF THE INVENTION

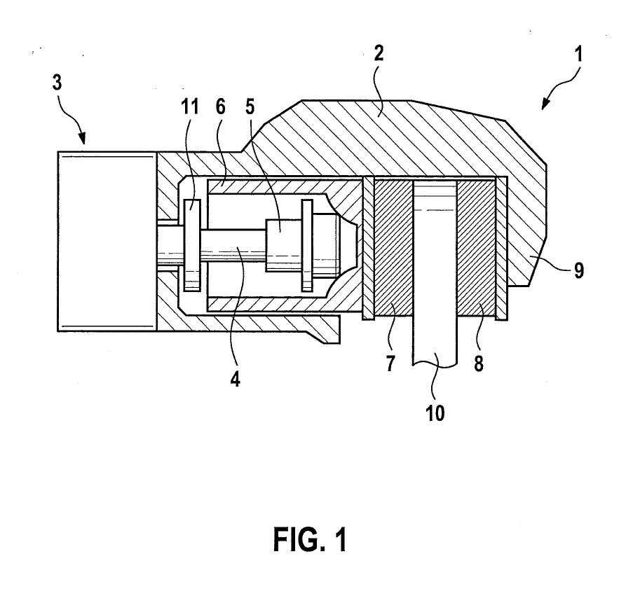

FIG. 1 shows an electromechanical parking brake 1 in a vehicle, a clamping force which holds the vehicle at a standstill being generatable via the parking brake. Parking brake 1 has a brake caliper 2 having a caliper unit 9 which reaches over brake disk 10. A brake motor 3 which is designed as an electric motor and which rotatingly drives a spindle 4, on which a spindle component 5 is displaceably installed, is used as the final control element of parking brake 1. Spindle component 5 is axially displaced when spindle 4 rotates. Spindle component 5 moves within a brake piston 6, which is the carrier of a brake lining 7 which is pressed by brake piston 6 against brake disk 10. Another brake lining 8, which is held in a fixed position on caliper unit 9, is situated on the opposite side of brake disk 10.

Within brake piston 6, spindle component 5 is able to move axially forward in the direction of the brake disk when spindle 4 rotates, and it is able to move axially rearward until a stop 11 is reached when spindle 4 rotates in the opposite direction. In order to generate a desirable setpoint clamping force, spindle component 5 acts upon the inner front side of brake piston 6, so that brake piston 6, which is supported axially displaceably in parking brake 1, is pressed with brake lining 7 against the facing front side of brake disk 10.

Furthermore, the hydraulic pressure of the regular hydraulic vehicle brake, using which the vehicle is braked during the travel, may act upon the brake piston. The hydraulic pressure may also actively support the parking brake when activated and when the vehicle is at a standstill so that the total clamping force is composed of the portion provided by the electric motor and the hydraulic portion.

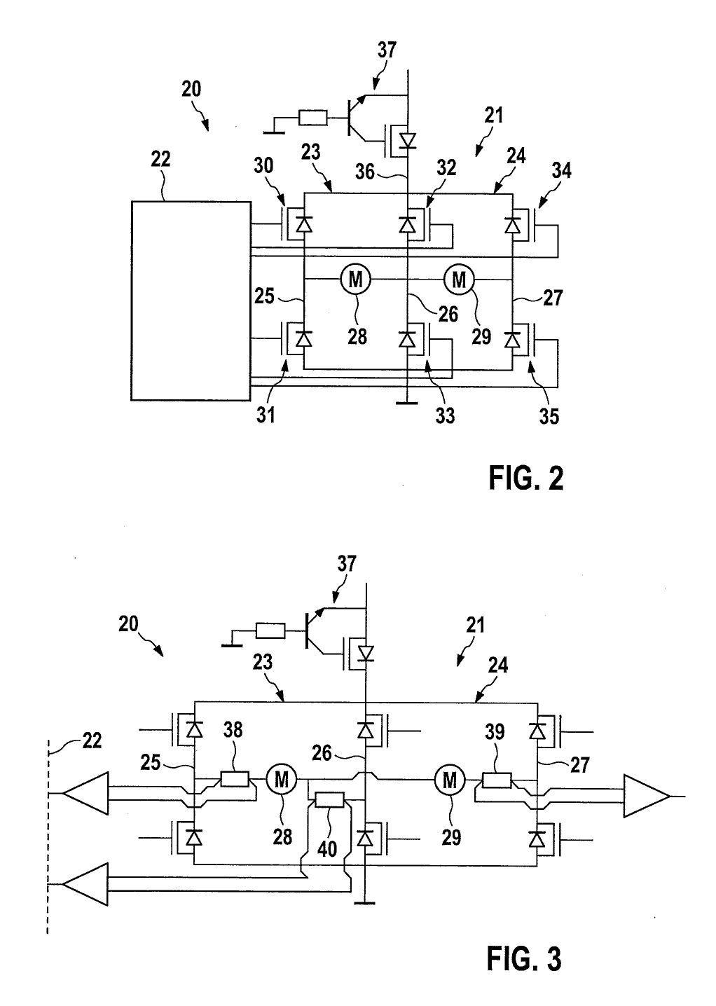

FIG. 2 shows a wiring diagram for controlling electric DC brake motors 28 and 29 which are part of the parking brake and have the structure according to FIG. 1. The two brake motors are located on the left and the right wheels of the rear axle of a vehicle and are controlled via a control unit 20 to carry out the engagement and the disengagement processes.

Control unit 20 includes a control electronics 21 having two interconnected H-bridges 23 and 24 as well as a driver unit 22 via which transistors 30 through 35 of the two H-bridges 23, 24 are controlled.

Each brake motor 28, 29 is assigned one H-bridge 23 and 24, respectively, which are, however, interconnected in such a way that the H-bridges have a shared middle half-bridge branch 26. In this way, brake motor 28 is assigned first H-bridge 23 having the two half-bridge branches 25 and 26, between which brake motor 28 is situated, and second brake motor 29 is assigned second H-bridge 24 having half-bridge branches 26 and 27, between which brake motor 29 is situated. In each half-bridge branch 25, 26, 27, two transistors 30 and 31, 32 and 33, 34 and 35, respectively, are located. Each transistor is assigned one diode.

The two H-bridges 23, 24 are connected to a voltage supply line 36 into which a polarity reversal protection 37 is integrated.

Transistors 30 through 35 in H-bridges 23, 24 are controlled and switched via driver unit 22 which is designed as a B6 or three-phase current bridge circuit and enables the setting of all transistors. Due to shared half-bridge branch 26, the two brake motors 28, 29 may each only be operated in the same direction of rotation despite the independent control. For example, transistor 30 in first half-bridge branch 25 and transistor 33 in second half-bridge branch 26 are activated for the engagement process via driver unit 22 for the forward direction of first brake motor 28. Similarly, transistor 34 in third half-bridge branch 27 is also activated by driver unit 22 for the engagement process of second brake motor 29. In first H-bridge 23, the current thus flows via transistor 30, first brake motor 28, and transistor 33; in second H-bridge 24, the current, however, flows via transistor 34, second brake motor 29, and transistor 33 during the engagement process. During the disengagement process, the direction of rotation of the brake motors is reversed; transistors 31, 32, and 35 are activated so that the current flows via transistor 32, first brake motor 28, and transistor 31 in first H-bridge 23 and via transistor 32, second brake motor 29, and transistor 35 in second H-bridge 24.

As is apparent from the wiring diagram according to FIG. 3, in which control unit 20 basically has the same structure as in the exemplary embodiment according to FIG. 2, the control unit may be equipped with measuring devices 38, 39, and 40 for measuring the current. Measuring devices 38 through 40 are an integral part of driver unit 22, i.e., the signals of the measuring devices are evaluated in driver unit 22. Measuring devices 38 through 40 each include a measuring shunt at which the voltage drop is measured. First measuring device 38 is assigned to first brake motor 28, and second measuring device 39 is assigned to second brake motor 29 to ascertain the respective motor currents. Third measuring device 40 is located in the shared current path of the two brake motors and is used to check the measuring devices assigned to the respective brake motors for plausibility, in that the current measured in third measuring device 40 must correspond to the sum of the individual currents which are measured in first and second measuring devices 38 and 39.

What is claimed is:

1. A parking brake in a vehicle, comprising:
two wheel brake units provided for two vehicle wheels, wherein each wheel brake unit has one electric DC brake motor for generating a clamping force which holds the vehicle at a standstill; and
a control unit controlling the electric DC brake motors, wherein the control unit includes two H-bridges assigned to the two brake motors, and wherein the two H-bridges assigned to the two brake motors are interconnected and include one shared half-bridge branch having two switches for controlling the two brake motors.

2. The parking brake as recited in claim 1, wherein the control unit has a shared driver unit for controlling the switches in the H-bridges.

3. The parking brake as recited in claim 2, wherein the driver unit is one of a B6 or three-phase current bridge circuit.

4. The parking brake as recited in claim 2, further comprising:
a plurality of measuring devices provided for measuring motor currents.

5. The parking brake as recited in claim 4, wherein the measuring devices are integrated into the driver unit.

6. The parking brake as recited in claim 4, wherein two measuring devices are assigned to the two brake motors, and a third measuring device is provided for redundantly measuring the motor currents.

7. The parking brake as recited in claim 6, wherein the switches are MOSFETs.

8. The parking brake as recited in claim 6, wherein the brake motors are brushless DC motors.

9. The parking brake as recited in claim 6, wherein a polarity reversal protection mechanism is integrated into a voltage supply line for the brake motors.
